(19) United States
(12) Patent Application Publication
(10) Pub. No.: US 2025/0052935 A1
(43) Pub. Date: Feb. 13, 2025

(54) OPTICAL FILTER

(71) Applicant: AGC Inc., Tokyo (JP)

(72) Inventors: Motoshi NAKAYAMA, Tokyo (JP); Takahiro SAKAGAMI, Shizuoka (JP); Takashi NAGATA, Shizuoka (JP); Kazuhiko SHIONO, Fukushima (JP)

(73) Assignee: AGC Inc., Tokyo (JP)

(21) Appl. No.: 18/922,524

(22) Filed: Oct. 22, 2024

Related U.S. Application Data
(63) Continuation of application No. PCT/JP2023/015700, filed on Apr. 19, 2023.

(30) Foreign Application Priority Data
Apr. 27, 2022 (JP) 2022-073741

(51) Int. Cl. G02B 5/22

(52) U.S. Cl. CPC G02B 5/22

(57) ABSTRACT

An optical filter includes: an absorber including an inorganic material including ytterbium; an absorption layer including a dye and a resin, the dye having a maximum absorption wavelength between 350 nm and 1,200 nm; and a dielectric multilayer film. The absorber may have a flat plate shape, and the absorber may have a thickness of 3 mm or less.

### CROSS-REFERENCE TO RELATED APPLICATIONS

This is a bypass continuation of International Patent Application No. PCT/JP2023/015700, filed on Apr. 19, 2023, which claims priority to Japanese Patent Application No. 2022-073741, filed on Apr. 27, 2022. The contents of these applications are hereby incorporated by reference in their entireties.

### TECHNICAL FIELD

The present invention relates to an optical filter that transmits light in a visible light region and shields light in a specific near-infrared light region.

### BACKGROUND ART

For an imaging device including a solid state image sensor, an application thereof is extended to a device that takes an image anytime during day and night, such as a monitoring camera or an in-vehicle camera. In such a device, it is necessary to acquire (color) images based on visible light and (monochrome) images based on infrared light.

Therefore, there has been studied use of an optical filter having, in addition to a near-infrared ray cut filter function for transmitting visible light and correctly reproducing an image based on the visible light, a function of selectively transmitting specific near-infrared light, that is, a dual band pass filter.

Patent Literature 1 discloses an optical filter in which a dielectric multilayer film and a resin substrate containing a near-infrared ray absorbing dye are combined, and near-infrared light around 850 nm and visible light are transmitted and other light is shielded.

Patent Literature 2 discloses an optical filter in which a dielectric multilayer film and a resin substrate containing a near-infrared ray absorbing dye are combined, and near-infrared light around 800 nm and visible light are transmitted and other light is shielded.

### CITATION LIST

### Patent Literature

Patent Literature 1: JP2021-6901A
Patent Literature 2: Japanese Patent No. 5884953

### SUMMARY OF INVENTION

In recent years, since laser light including a partial region of 800 nm to 1,000 nm is used in a sensor in the imaging field, an optical filter that can transmit near-infrared light of such a sensing region and shield other near-infrared light that causes noise is required.

In an optical filter including a dielectric multilayer film, since an optical film thickness of the dielectric multilayer film changes depending on an incident angle of light, there is such a problem that a spectral transmittance curve changes depending on the incident angle. For example, as the incident angle of light increases, reflection characteristics shift to a short wavelength side, and as a result, the reflection characteristics may deteriorate in a region to be originally shielded. Such a phenomenon is likely to occur more strongly as the incident angle is larger. When such a filter is used, spectral sensitivity of the solid state image sensor may be affected by the incident angle. With a reduction in height of camera modules in recent years, use under a condition of a high incident angle is assumed, and therefore an optical filter that is hardly affected by an incident angle is required.

A shift in a visible light transmission region or a region switched from a short wavelength side near-infrared light shielding region to a near-infrared light transmission region can be reduced by using an absorbing material such as a dye. On the other hand, it is difficult to reduce a shift in a region switched from the near-infrared light transmission region to a long wavelength side near-infrared light shielding region by the absorbing material. When the shift is large only in this region, a transmitted light amount of the near-infrared light is changed depending on the incident angle, and a ratio of captured light amounts of visible light and infrared light in the solid state image sensor is also changed depending on the incident angle. As a result, color reproducibility of a (color) image based on the visible light and reproducibility of a (monochrome) image based on the infrared light may be affected.

In this regard, the optical filter disclosed in Patent Literature 2 has room for improvement in terms of reducing a shift of a spectral curve with respect to light at a high incident angle.

An object of the present invention is to provide an optical filter that has excellent transmittance for visible light, excellent shielding properties for specific near-infrared light, and a small shift of a spectral curve even at a high incident angle.

The present invention provides an optical filter having the following configuration.
[1] An optical filter including:
an absorber including an inorganic material including ytterbium;
an absorption layer including a dye and a resin, the dye having a maximum absorption wavelength between 350 nm and 1,200 nm; and
a dielectric multilayer film.

According to the present invention, an optical filter that has excellent transmittance for visible light and excellent shielding properties for specific near-infrared light even at a high incident angle can be provided. The optical filter according to the present invention is particularly an optical filter in which a spectral transmittance curve of a boundary region between a transmission region of a near-infrared light region of 800 nm to 1,000 nm, which is a sensing wavelength region, and a wavelength region on a long wavelength side to be shielded is hardly shifted depending on an incident angle even at a high incident angle, and which is hardly affected by the incident angle.

### BRIEF DESCRIPTION OF DRAWINGS

FIG. 1 is a cross-sectional view schematically illustrating an example of an optical filter according to one embodiment.

FIG. 2 is a cross-sectional view schematically illustrating another example of the optical filter according to one embodiment.

FIG. 3 is a diagram illustrating spectral transmittance curves of Yb-containing glasses 1 to 3 and an alkali glass.

FIG. 4 is a diagram illustrating optical density curves of the Yb-containing glasses 1 to 3.

FIG. 5 is a diagram illustrating a spectral transmittance curve of Yb-containing glass 4.

FIG. 6 is a diagram illustrating an optical density curve of the Yb-containing glass 4.

FIG. 7 is a diagram illustrating spectral transmittance curves of ceramics.

FIG. 8 is a diagram illustrating optical density curves of the ceramics.

FIG. 9 is a diagram illustrating spectral transmittance curves of absorption layers of Examples 1-1 and 1-2.

FIG. 10 is a diagram illustrating optical density curves of the absorption layers of Examples 1-1 and 1-2.

FIG. 11 is a diagram illustrating spectral transmittance curves and spectral reflectance curves of an optical filter in Example 2-1.

FIG. 12 is a diagram illustrating spectral transmittance curves of an optical filter in Example 2-2.

FIG. 13 is a diagram illustrating spectral transmittance curves of an optical filter of Example 2-3.

FIG. 14 is a diagram illustrating spectral transmittance curves and spectral reflectance curves of an optical filter in Example 2-4.

FIG. 15 is a diagram illustrating spectral transmittance curves of an optical filter in Example 2-5.

FIG. 16 is a diagram illustrating spectral transmittance curves of an optical filter in Example 2-6.

FIG. 17 is a diagram illustrating spectral transmittance curves of an optical filter of Example 2-7.

FIG. 18 is a diagram illustrating spectral transmittance curves of an optical filter of Example 2-8.

### DESCRIPTION OF EMBODIMENTS

Hereinafter, embodiments of the present invention will be described.

In the present description, a near-infrared ray absorbing dye may be abbreviated as an “NIR dye”, and an ultraviolet absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. In addition, a group represented by the formula (I) is also referred to as a group (I), and the same applies to groups represented by other formulae.

In the present description, internal transmittance is transmittance obtained by subtracting an influence of interface reflection from measured transmittance, which is represented by a formula of {measured transmittance (incident angle of 0 degrees)/(100−reflectance (incident angle of 5 degrees))}×100.

In the present description, the optical density represents a value converted from the internal transmittance by the following formula.

$$Optical density at wavelength of λ nm = - log 10 ( {iT}_{λ} / 100 )$$

iT_{λ}: internal transmittance at an incident angle of 0 degrees at a wavelength of λ nm

In the present description, transmittance of glass and a spectrum of transmittance of an absorption layer including a case where a dye is contained in a resin are both “internal transmittance” even when described as “transmittance”. On the other hand, transmittance measured by dissolving a dye in a solvent such as dichloromethane, transmittance of a dielectric multilayer film, and transmittance of an optical filter including the dielectric multilayer film are measured transmittance.

In the present description, transmittance of, for example, 90% or more in a specific wavelength region means that the transmittance does not fall below 90% in the entire wavelength region, that is, minimum transmittance is 90% or more in the wavelength region.

Similarly, transmittance of, for example, 1% or less in a specific wavelength region means that the transmittance does not exceed 1% in the entire wavelength region, that is, maximum transmittance is 1% or less in the wavelength region. The same applies to the internal transmittance. Average transmittance and average internal transmittance in the specific wavelength region are an arithmetic mean of transmittance and internal transmittance per 1 nm in the wavelength region.

Spectral characteristics can be measured by using an ultraviolet-visible spectrophotometer.

In the present description, the symbol “-” or the word “to” that is used to express a numerical range includes the numerical values before and after the symbol or the word as the upper limit and the lower limit of the range, respectively.

### <Optical Filter>

An optical filter according to one embodiment of the present invention (hereinafter, also referred to as “the filter”) includes an absorber including an inorganic material containing ytterbium, an absorption layer containing a dye having a maximum absorption wavelength between 350 nm and 1,200 nm and a resin, and a dielectric multilayer film.

Reflection characteristics of the dielectric multilayer film and absorption characteristics of the absorber and the absorption layer allow the optical filter as a whole to achieve excellent transmittance in a visible light region and a specific near-infrared light region, and excellent shielding properties in another near-infrared light region.

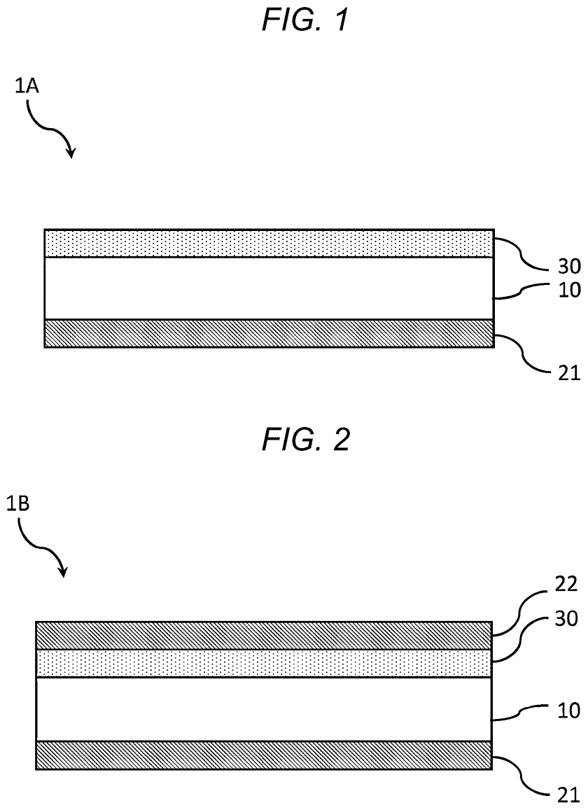

An example of a configuration of the filter will be described with reference to the drawings. FIGS. 1 and 2 are cross-sectional views schematically illustrating examples of the optical filter according to one embodiment.

An optical filter 1A illustrated in FIG. 1 is an example including an absorber 10 including an inorganic material containing ytterbium, a dielectric multilayer film 21 laminated on one main surface of the absorber 10, and an absorption layer 30 provided on the other main surface of the absorber 10.

An optical filter 1B illustrated in FIG. 2 is an example in which a dielectric multilayer film 22 is further provided on a surface of the absorption layer 30.

### <Absorber>

An absorber including an inorganic material containing ytterbium is provided. The inorganic material containing ytterbium is excellent in transmittance in the visible light region and transmittance in a region from visible light to near-infrared light of about 800 nm, and absorbs light in a near-infrared light region of 850 nm or more, particularly a near-infrared light region of 900 nm to 1,000 nm. In addition, since light is shielded by the absorption characteristic, light shielding properties are not affected by the incident angle unlike the dielectric multilayer film. Therefore, by using the inorganic material containing ytterbium, when the sensing wavelength region is particularly 800 nm to 900 nm, an optical filter is obtained in which transmittance in the near-infrared light region is excellent even at a high incident angle, a spectral transmittance curve of a boundary region between such a transmission region and a wavelength region of 900 nm or more to be shielded is hardly shifted depending on an incident angle, and which is hardly affected by the incident angle.

Further, since an absorption band of the inorganic material containing ytterbium is steep, transmittance of a region other than the maximum absorption wavelength region can be kept high. On the other hand, in the optical filter disclosed in Patent Literature 1 described above, light on a longer wavelength side than the sensing wavelength region is mainly shielded by an absorption ability of a near-infrared light absorbing dye, and thus transmittance of a sensing wavelength may also decrease.

The absorber preferably satisfies the following spectral characteristic (iii-1).
(iii-1) An average optical density OD_{940-960_AVE} at a wavelength of 940 nm to 960 nm/an average optical density OD_{840-860_AVE} at a wavelength of 840 nm to 860 nm>5.

A ratio of the spectral characteristic (iii-1) increases as an average transmittance at the wavelength of 840 nm to 860 nm increases and an average transmittance at the wavelength of 940 nm to 960 nm decreases. When the ratio of the spectral characteristic (iii-1) is larger than 5, it means that the absorber sufficiently transmits near-infrared light of the wavelength of 840 nm to 860 nm and sufficiently absorbs near-infrared light of the wavelength of 940 nm to 960 nm. The ratio of the spectral characteristic (iii-1) is more preferably 10 or more, and still more preferably 20 or more.

The absorber still more preferably satisfies the following spectral characteristic (iii-2).
(iii-2) An average optical density OD_{920-930_AVE} at a wavelength of 920 nm to 930 nm/an average optical density OD_{870-880_AVE} at a wavelength of 870 nm to 880 nm>3.

A ratio of the spectral characteristic (iii-2) is more preferably 5 or more, and still more preferably 7 or more.

The absorber still more preferably satisfies the following spectral characteristic (iii-3).
(iii-3) An optical density OD₁₀₀₀ at a wavelength of 1,000 nm/an optical density OD₈₀₀ at a wavelength of 800 nm>10.

A ratio of the spectral characteristic (iii-3) increases as a transmittance at the wavelength of 800 nm increases and a transmittance at the wavelength of 1,000 nm decreases. When the ratio of the spectral characteristic (iii-3) is larger than 10, it means that the absorber sufficiently transmits near-infrared light of a wavelength around 800 nm and sufficiently absorbs near-infrared light of a wavelength around 1,000 nm. The ratio of the spectral characteristic (iii-3) is more preferably 50 or more.

Examples of the inorganic material containing ytterbium include a single crystal and a polycrystalline sintered body such as Yb₂O₃, Yb:YAG (Yttrium Aluminum Garnet), Yb:YVO₄, and the like, a glass containing ytterbium, and the like. Among those, a glass containing ytterbium is more preferable from the viewpoint of processability, stability of material quality, and ease of adjusting physical properties.

The ytterbium-containing glass preferably has a maximum absorption wavelength of 940 nm to 1,000 nm.

It is preferable that in the ytterbium-containing glass, an average of internal transmittance at a wavelength of 450 nm to 600 nm and an incident angle of 0 degrees be 60% or more, more preferably 80% or more, and still more preferably 90% or more.

It is preferable that in the ytterbium-containing glass, an average of internal transmittance at a wavelength of 700 nm to 800 nm and an incident angle of 0 degrees be 60% or more, more preferably 80% or more, and still more preferably 90% or more.

Examples of the ytterbium-containing glass include a glass having any of the following compositions.

(1) Glass containing Yb₂O₃ and B₂O₃ as essential components in terms of mol % based on an oxide, in which a content of Yb₂O₃ is 10 mol % to 60 mol %, and a content of B₂O₃ is 10 mol % to 70 mol %.

(2) Glass further containing SiO₂ as an essential component in addition to (1), in which a content of SiO₂ is 5 mol % to 35 mol %.

(3) Glass further containing La₂O₃ as an essential component in addition to (1) and (2), in which a content of La₂O₃ is 1 mol % to 20 mol %.

As the ytterbium-containing glass, a commercially available product may be used, and the ytterbium-containing glass can be manufactured by known methods disclosed in Japanese Laid-Open Patent Publication No. S61-163138, Japanese Laid-Open Patent Publication No. S56-78447, and the like.

In addition, as the ytterbium-containing glass, there may be used chemically strengthened glass obtained by exchanging, in glass having a composition containing an alkali metal, alkali metal ions (for example, Li ions and Na ions) having a small ionic radius present on a main surface of a glass plate with alkali ions having a larger ionic radius (for example, Na ions or K ions with respect to Li ions and K ions with respect to Na ions) by ion exchange at a temperature equal to or lower than a glass transition point.

In a case where the inorganic material containing ytterbium is a single crystal containing ytterbium or a polycrystalline sintered body containing ytterbium, the single crystal or the polycrystalline sintered body preferably contains 10 mol % or more of Yb₂O₃ in terms of mol % based on an oxide, or has a doping amount of Yb of 10 at % or more in terms of a composition ratio of Yb to an element to be replaced by Yb in a base material and Yb.

For example, in the case of YAG, Y in Y₃Al₅O₁₂ is replaced by Yb, and thus [Yb/(Yb+Y)]×100 is preferably 10 at % or more.

From the viewpoint of having a function as a support for maintaining a shape of the optical filter, a shape of the absorber is preferably a flat plate shape, a wedge-shaped flat plate shape, a curved shape having a constant thickness, or a lens shape having a wall thickness deviation, and particularly preferably a flat plate shape.

The absorber has a thickness of preferably 3 mm or less, more preferably 2 mm or less, and still more preferably 1 mm or less from the viewpoint of ease of optical design when incorporated into a camera module, and the thickness is preferably 0.1 mm or more from the viewpoint of device strength and a necessity of obtaining desired optical characteristics.

### <Absorption Layer>

The filter includes an absorption layer containing a dye having a maximum absorption wavelength between 350 nm and 1,200 nm and a resin. Accordingly, it is possible to compensate for a region where light is not shielded by the reflection characteristics of the dielectric multilayer film by the absorption characteristic of the dye.

In addition, various kinds of band pass filters can be designed by appropriately selecting the maximum absorption wavelength region of the dye in consideration of a matter that an absorption region of the absorber including the inorganic material containing ytterbium is mainly 900 nm to 1,000 nm.

For example, when the dye in the absorption layer is a near-infrared light absorbing dye having a maximum absorption wavelength in a wavelength region shorter than 800 nm, a dual passband filter that selectively transmits visible light and near-infrared light of 800 nm to 900 nm is obtained.

Hereinafter, a case where the dye in the absorption layer is the near-infrared light absorbing dye having a maximum absorption wavelength in the wavelength region shorter than 800 nm (hereinafter, also referred to as a “dye X_{800S}”) will be described.

The absorption layer containing the dye X_{800S} preferably satisfies both the following spectral characteristics (ii-1) and (ii-2).
(ii-1) When a shortest wavelength at which an internal transmittance is 30% in a spectral transmittance curve at a wavelength of 650 nm to 720 nm is λ_{A_VIS(30%)}, and a shortest wavelength at which an internal transmittance is 30% in a spectral transmittance curve at a wavelength of 720 nm to 1,000 nm is λ_{A_IR(30%)}, the following relational expression is satisfied:

$$\vert {λ}_{A \_ IR ( 30 \% )} - {λ}_{A \_ VIS ( 30 \% )} \vert \geq 100 nm .$$

(ii-2) When an optical density at a wavelength of 450 nm is OD_₄₅₀ and an optical density at a wavelength of 720 nm is OD_₇₂₀, the following relational expression is satisfied:

$${OD}_{\_ 720} - {OD}_{\_ 450} \geq 1.$$

|λ_{A_IR(30%)}-λ_{A_VIS(30%)}| in the characteristic (ii-1) is an index of a near-infrared light absorption band centered at 720 nm, and being 100 nm or more means that the absorption layer absorbs a wide range of light in the region.

|λ_{A_IR(30%)}-λ_{A_VIS(30%)}| is more preferably 120 nm or more. In addition, |λ_{A_IR(30%)}-λ_{A VIS(30%)}| is preferably 150 nm or less from the viewpoint that it is more difficult to keep the transmittance in the visible light region high as the maximum absorption wavelength of the dye is in a long wavelength region.

In order to satisfy the characteristic (ii-1), for example, a combination of two kinds of dyes having different maximum absorption wavelengths and existing in a region of 680 nm to 800 nm, preferably a combination of a dye having a maximum absorption wavelength in 680 nm to 740 nm and a dye having a maximum absorption wavelength in 740 nm to 800 nm may be used as the near-infrared ray absorbing dye. In addition, a squarylium dye may be used from the viewpoint of achieving a wide range absorption with a small addition amount.

The characteristic (ii-2) means that the absorption layer achieves both high visible light transmittance at 450 nm and high near-infrared light shielding properties at 720 nm.

O_{D_720}-OD_₄₅₀ is preferably 1.5 or more, and more preferably 2 or more.

In order to satisfy the characteristic (ii-2), for example, a squarylium dye of a symmetrical type may be used as the near-infrared ray absorbing dye from the viewpoint of strongly absorbing light around 720 nm and maintaining high transmittance in the visible light region.

The dye X_{800S} is preferably a dye having a maximum absorption wavelength in a wavelength region of 680 nm to 800 nm in dichloromethane (hereinafter, also referred to as an “NIR dye”). By including such a dye, as shown in the above-mentioned characteristics (ii-1) and (ii-2), the absorption layer can absorb a wide range of light in the near-infrared light absorption band centered at 720 nm, and can easily achieve both the visible light transmittance at 450 nm and the near-infrared light shielding properties at 720 nm.

From the viewpoint of being able to absorb a wide range of light in the near-infrared region, a combination of two kinds of dyes having different maximum absorption wavelengths and existing in a region of 680 nm to 800 nm, preferably a combination of a dye having a maximum absorption wavelength in 680 nm to 740 nm and a dye having a maximum absorption wavelength in 740 nm to 800 nm may be used.

The NIR dye is preferably at least one selected from the group consisting of a squarylium dye, a cyanine dye, a phthalocyanine dye, a naphthalocyanine dye, a dithiol metal complex dye, an azo dye, a polymethine dye, a phthalide dye, a naphthoquinone dye, an anthraquinone dye, an indophenol dye, a pyrylium dye, a thiopyrylium dye, a croconium dye, a tetradehydrocholine dye, a triphenylmethane dye, an aminium dye, and a diimmonium dye.

The NIR dye preferably contains at least one dye selected from a squarylium dye, a phthalocyanine dye, and a cyanine dye. Among these NIR dyes, a squarylium dye and a cyanine dye are preferable from the viewpoint of spectroscopy, and a phthalocyanine dye is preferable from the viewpoint of durability.

A content of the NIR dye in the absorption layer is preferably 0.1 parts by mass to 25 parts by mass, and more preferably 0.3 parts by mass to 15 parts by mass with respect to 100 parts by mass of the resin. In a case where two or more compounds are combined, the above-mentioned content is a sum of respective compounds.

The absorption layer may include other dyes in addition to the above-mentioned NIR dye. Examples of the other dyes preferably include a dye (UV dye) having a maximum absorption wavelength in 370 nm to 440 nm in the resin. Accordingly, a near ultraviolet region can be efficiently shielded.

Examples of the UV dye include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Among those, the merocyanine dye is particularly preferable. In addition, these dyes may be used alone, or may be used in combination of two or more kinds thereof.

The absorption layer is preferably laminated on or above at least one main surface of the absorber. Since the absorber is an inorganic material as described above, the absorber can have both a near-infrared light absorption ability and a function as a support.

The resin in the absorption layer is not limited as long as it is a transparent resin, and one or more kinds of transparent resins selected from a polyester resin, an acrylic resin, an epoxy resin, an ene-thiol resin, a polycarbonate resin, a polyether resin, a polyarylate resin, a polysulfone resin, a polyethersulfone resin, a poly(p-phenylene) resin, a polyarylene ether phosphine oxide resin, a polyamide resin, a polyimide resin, a polyamide-imide resin, a polyolefin resin, a cyclic olefin resin, a polyurethane resin, a polystyrene resin, and the like are used. These resins may be used alone, or may be used by mixing two or more kinds thereof.

From the viewpoint of spectral characteristics, glass transition point (Tg), and adhesion of the absorption layer, one or more kinds of resins selected from a polyimide resin, a polycarbonate resin, a polyester resin, and an acrylic resin are preferable.

In a case where a plurality of compounds are used as the NIR pigment or other pigments, those compounds may be included in the same absorption layer or may be included in different absorption layers.

The absorption layer can be formed by dissolving or dispersing a dye, a resin or raw material components of the resin, and respective components blended as necessary in a solvent to prepare a coating solution, applying the coating solution to a support, drying the coating solution, and further curing the coating solution as necessary. The support may be the above-described absorber or may be a peelable support used only when a resin film is formed. In addition, the solvent may be a dispersion medium capable of stably dispersing components or a solvent capable of dissolving components.

In addition, the coating solution may contain a surfactant in order to improve voids due to fine bubbles, depressions due to adhesion of foreign substances and the like, and repelling in a drying process. Further, for the application of the coating solution, for example, a dip coating method, a cast coating method, or a spin coating method can be used. In addition, in a case where the coating solution contains a raw material component of the transparent resin, a curing process such as thermal curing or photocuring is further performed.

The absorption layer can also be manufactured into a film shape by extrusion molding. The filter can be manufactured by laminating the obtained film-shaped absorption layer on the absorber and integrating those by thermal press fitting or the like.

The absorption layer may be provided in the optical filter by one layer or two or more layers. In a case where the absorption layer is provided by two or more layers, each of the layers may have the same configuration or a different configuration, and two or more layers may be stacked on or above one surface of the dielectric multilayer film even when the absorption layers are formed on or above each of the surfaces of the dielectric multilayer films.

A thickness of the absorption layer is 10 μm or less and preferably 5 μm or less from the viewpoint of in-plane film thickness distribution and appearance quality in a substrate after coating, and is preferably 0.5 μm or more from the viewpoint of exhibiting desired spectral characteristics at an appropriate dye concentration. In a case where the optical filter has two or more layers of absorption layers, a total thickness of each of the absorption layers is preferably within the above-mentioned range.

### <Dielectric Multilayer Film>

The filter includes a dielectric multilayer film. The filter may have one or more dielectric multilayer films, at least one of which is preferably designed as a reflective film (hereinafter, also referred to as an “NIR reflective film”) that reflects a part of near-infrared light. Other dielectric multilayer films may be designed as a reflection layer having a reflection region other than a near-infrared region, or an antireflection layer.

The NIR reflection layer has, for example, wavelength selectivity of transmitting visible light, transmitting near-infrared light in a transmission region of the absorption layer, and mainly reflecting other near-infrared light. The NIR reflection layer may be further appropriately designed to have a specification further reflecting light in a wavelength range other than the near-infrared light, for example, near ultraviolet light.

As a dielectric multilayer film when designed as the NIR reflection layer, it is preferable that the following spectral characteristics be satisfied.

(iv-1) When the dielectric multilayer film designed as the NIR reflection layer is used as a plane of incidence, an average reflectance R_{D 450-600 AVE} in a spectral reflectance curve at a wavelength of 450 nm to 600 nm and an incident angle of 5 degrees of the optical filter is 3% or less.

(iv-2) When the dielectric multilayer film designed as the NIR reflection layer is used as the plane of incidence, an average reflectance R_{D_1000-1200 AVE} in a spectral reflectance curve at a wavelength of 1,000 nm to 1,200 nm and an incident angle of 5 degrees of the optical filter is 40% or more.

A part of the near-infrared light region of 700 nm to 1,000 nm needs to have a certain degree of transmittance according to a sensing wavelength region of an element on which the optical filter is mounted. In consideration of the reflection characteristics of the dielectric multilayer film and the absorption characteristics of the absorbing material, the reflection characteristics of the dielectric multilayer film can be appropriately designed so as to achieve target transmittance for the entire optical filter.

The NIR reflection layer includes, for example, a dielectric multilayer film in which dielectric films having a low refractive index (low refractive index films) and dielectric films having a high refractive index (high refractive index films) are alternately laminated. The high refractive index film preferably has a refractive index of 1.6 or more, and more preferably 2.2 to 2.5. Examples of a material of the high refractive index film include Ta₂O₅, TiO₂, and Nb₂O₅. Among those, TiO₂ is preferable from the viewpoint of reproducibility in film formability and refractive index, stability, and the like.

On the other hand, the low refractive index film preferably has a refractive index of less than 1.6, and more preferably 1.45 or more and less than 1.55. Examples of a material of the low refractive index film include SiO₂ and SiOₓN_{y}. SiO₂ is preferable from the viewpoint of reproducibility in film formability, stability, economic efficiency, and the like.

In order for the NIR reflection layer to transmit visible light and specific near-infrared light, several kinds of dielectric multilayer films having different spectral characteristics may be combined when transmitting and selecting a desired wavelength band.

For example, adjustment can be made according to a material constituting the film, a film thickness of each layer, and the number of layers.

In the NIR reflection layer, the total number of laminated layers of the dielectric multilayer films constituting the reflection layer is preferably 20 or more, and more preferably 25 or more from the viewpoint of controlling a wavelength band subjected to transmission and light shielding, and is preferably 60 or less from the viewpoint of preventing a ripple.

The film thickness of the dielectric multilayer film is preferably 100 nm or more, and more preferably 300 nm or more from the viewpoint of preventing deterioration of the absorbing material, and is preferably 5 μm or less from the viewpoint of productivity and prevention of a reflection ripple in the visible light region.

For formation of the dielectric multilayer film, for example, a vacuum film formation process such as a CVD method, a sputtering method, or a vacuum deposition method, a wet film formation process such as a spraying method or a dipping method, or the like can be used.

The NIR reflection layer may provide predetermined optical characteristics by one layer (one group of dielectric multilayer films) or may provide the predetermined optical characteristics by two layers. When two or more NIR reflection layers are provided, the respective reflection layers may have the same configuration or different configurations. In the case where two or more reflection layers are provided, generally the NIR reflection layer may be formed of a plurality of reflection layers having different reflection bands. In a case where two reflection layers are provided, one of the reflection layers may be a near-infrared reflection layer that shields light in a short wavelength band in the near-infrared region, and the other of the reflection layers may be a near-infrared and near ultraviolet reflection layer that shields light in both a long wavelength band of the near-infrared region and a near ultraviolet region.

The other dielectric multilayer films may be designed as an antireflection layer. Examples of the antireflection layer include a dielectric multilayer film, an intermediate refractive index medium, and a moth-eye structure in which the refractive index gradually changes. Among those, the dielectric multilayer film is preferable from the viewpoint of optical efficiency and productivity. The antireflection layer is obtained by alternately laminating a dielectric film having a high refractive index and a dielectric film having a low refractive index similarly to the reflection layer.

The filter may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have high visible light transmittance and have light absorbing properties in a wide range of an infrared wavelength region exceeding 1,200 nm, and thus can be used in a case where shielding properties of infrared light is required.

### <Optical Filter>

The optical filter according to the present invention preferably satisfies the following spectral characteristic.

(i-1) In a spectral transmittance curve at a wavelength of 450 nm to 600 nm and an incident angle of 0 degrees, an average transmittance T_{450-600(0 deg)AVE} is 60% or more.

Satisfying the spectral characteristic (i-1) means that transmittance in a visible light region of 450 nm to 600 nm is excellent.

T_{450-600(0 deg)AVE} is preferably 80% or more, and more preferably 88% or more.

In addition, in order to satisfy the spectral characteristic (i-1), for example, the dielectric multilayer film having excellent transmittance in the visible light region, or a dye having excellent transmittance in the visible light region may be used.

The optical filter according to the present invention preferably satisfies the following spectral characteristic.

(i-2) In a spectral transmittance curve at a wavelength of 800 nm to 900 nm and an incident angle of 0 degrees, a maximum transmittance T_{800-900(0 deg)MAX} is 60% or more.

Satisfying the spectral characteristic (i-2) means that transmittance in a near-infrared light region of 800 nm to 900 nm is excellent.

T_{800-900(0 deg)MAX} is preferably 70% or more, more preferably 80% or more, and still more preferably 85% or more.

In addition, in order to satisfy the spectral characteristic (i-2), for example, a dielectric multilayer film excellent in transmittance of the near-infrared light region of 800 nm to 900 nm may be used.

The optical filter according to the present invention preferably satisfies the following spectral characteristic.

(i-3) In a spectral transmittance curve at a wavelength of 930 nm to 950 nm and an incident angle of 0 degrees, a maximum transmittance T_{930-950(0 deg)MAX} is 20% or less.

Satisfying the spectral characteristic (i-3) means that shielding properties of a near-infrared light region of 930 nm to 950 nm are excellent.

T_{930-950(0 deg)MAX} is preferably 16% or less, more preferably 12% or less, still more preferably 8% or less.

In addition, in order to satisfy the spectral characteristic (i-3), for example, light may be shielded by an absorption ability of an ytterbium-containing inorganic material.

The optical filter according to the present invention preferably satisfies the following spectral characteristic.

(i-4) in the spectral transmittance curve at a wavelength of 800 nm to 1,000 nm and an incident angle of 0 degrees, when a wavelength at which the maximum transmittance is obtained is λ_{800-1000(0 deg)MAX},
a wavelength λ_{IRL(0 deg)(50%)} at which a transmittance is 50% in a wavelength region longer than λ_{800-1000(0 deg)MAX} and at an incident angle of 0 degrees and a wavelength λ_{IRL(35 deg)(50%)} at which a transmittance is 50% in the wavelength region longer than λ_{800-1000(0 deg)MAX} and at an incident angle of 35 degrees satisfy the following relational expression:

|λ_{IRL(0 deg)(50%)}−λ_{IRL(35 deg)(50%)}|≤15 nm.

Satisfying the spectral characteristic (i-4) means that a spectral curve in a wavelength region of 800 nm to 1,000 nm is less likely to shift in a wavelength region longer than a maximum absorption wavelength even at a high incident angle.

|λ_{IRL(0 deg)(50%)}-λ_{IRL(35 deg)(50%)}| is preferably 12 nm or less, more preferably 10 nm or less, and still more preferably 8 nm or less.

In order to satisfy the spectral characteristic (i-4), for example, light may be shielded by the absorption ability of the ytterbium-containing inorganic material.

As described above, the optical filter according to the present invention has excellent transmittance for visible light, excellent shielding properties for specific near-infrared light, and excellent spectral characteristics in which a shift of the spectral curve is small even at a high incident angle.

### <Imaging Device>

The imaging device according to the present invention preferably includes the optical filter according to the present invention. The imaging device preferably further includes a solid state image sensor and an imaging lens. By providing the filter which is excellent in transmittance of visible light and has shielding properties of specific near-infrared light, it is possible to obtain an imaging device excellent in color reproducibility even for light at a high incident angle.

As described above, the present invention relates to the following optical filter and the like.
[1] An optical filter including:
an absorber including an inorganic material including ytterbium;
an absorption layer including a dye and a resin, the dye having a maximum absorption wavelength between 350 nm and 1,200 nm; and
a dielectric multilayer film.
[2] The optical filter according to [1], in which the absorber has a flat plate shape.
[3] The optical filter according to [1] or [2], in which the absorber has a thickness of 3 mm or less.
[4] The optical filter according to any of [1] to [3], in which the absorber includes a glass including ytterbium, and
the glass includes 10 mol % or more of Yb₂O₃ in terms of mol % based on an oxide.
[5] The optical filter according to any of [1] to [4], in which the absorber includes a single crystal including ytterbium or a polycrystalline sintered body including ytterbium, and
the single crystal or the polycrystalline sintered body includes 10 mol % or more of Yb₂O₃ in terms of mol % based on an oxide, or has a doping amount of Yb of 10 at % or more in terms of a composition ratio of Yb to an element to be replaced by Yb in a base material and Yb.
[6] The optical filter according to any of [1] to [5], in which the absorber satisfies the following spectral characteristic (iii-1).
(iii-1) An average optical density OD_{940-960_AVE} at a wavelength of 940 nm to 960 nm/an average optical density OD_{840-860_AVE} at a wavelength of 840 nm to 860 nm>5.
[7] The optical filter according to any of [1] to [6], in which the absorber satisfies the following spectral characteristic (iii-2).
(iii-2) An average optical density OD_{920-930_AVE at a wavelength of} 920 nm to 930 nm/an average optical density OD₈₇₀-8₈₀_AVE at a wavelength of 870 nm to 880 nm>3.
[8] The optical filter according to any of [1] to [7], in which the following spectral characteristic (i-2) is satisfied.
(i-2) In a spectral transmittance curve at a wavelength of 800 nm to 900 nm and an incident angle of 0 degrees, a maximum transmittance T_{800-900(0 deg)MAX} is 60% or more.
[9] The optical filter according to any of [1] to [8], in which the following spectral characteristic (i-3) is satisfied.
(i-3) In a spectral transmittance curve at a wavelength of 930 nm to 950 nm and an incident angle of 0 degrees, a maximum transmittance T_{930-950(0 deg)MAX} is 20% or less.
[10] The optical filter according to any of [1] to [9], in which the following spectral characteristic (i-1) is satisfied.
(i-1) In a spectral transmittance curve at a wavelength of 450 nm to 600 nm and an incident angle of 0 degrees, an average transmittance T_{450-600(0 deg)AVE} is 60% or more.
[11] An imaging device including the optical filter according to any of [1] to [10].

### EXAMPLE

Next, the present invention will be described more specifically with reference to examples.

For measurement of each spectral characteristic, an ultraviolet-visible spectrophotometer (UH-4150 type, manufactured by Hitachi High-Tech Corporation) was used.

The spectral characteristic in a case where an incident angle is not particularly specified is a value measured at an incident angle of 0 degrees (in a direction perpendicular to a main surface of an optical filter).

Dyes used in respective examples are as follows.
Compound 1 (squarylium compound): synthesized based on U.S. Pat. No. 5,543,086.
Compound 2 (squarylium compound): synthesized based on WO2017/135359.
Compound 3 (merocyanine compound): synthesized based on the description of German Patent No. 10109243.
Compound 4 (cyanine compound): synthesized based on Dyes and pigments 73 (2007) 344-352.
Compound 5 (squarylium compound): synthesized based on JP2020-31198A.

The compound 1, the compound 2, the compound 4, and the compound 5 are near-infrared ray absorbing dyes (NIR dyes), and the compound 3 is a near ultraviolet absorbing dye (UV dye).

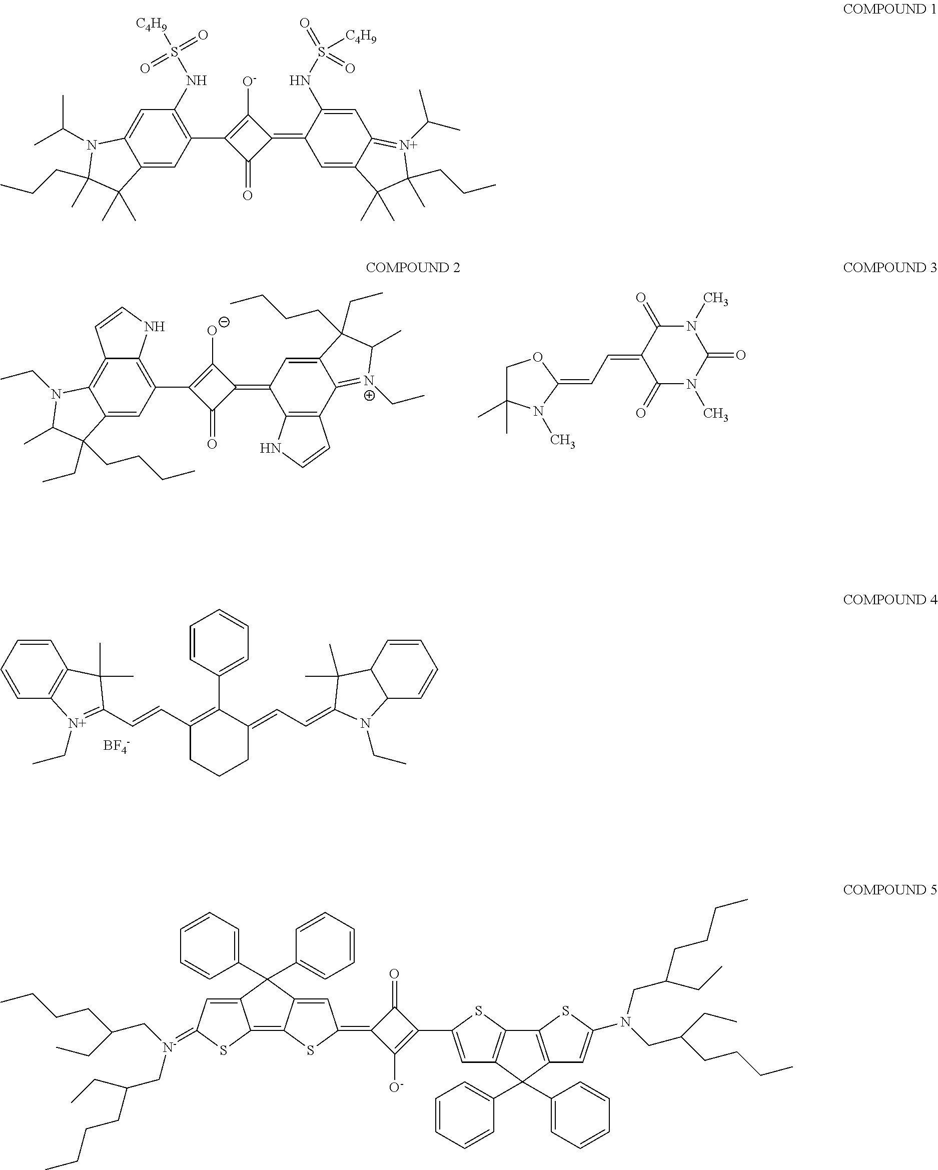

### <Spectral Characteristics of Dye>

Each of the above-mentioned dyes (compounds 1 to 5) is dissolved in a polyimide resin C-3G30G manufactured by Mitsubishi Gas Chemical Company, Inc. and a maximum absorption wavelength in a measured absorption spectrum is shown.

TABLE 1

| | Maximum absorption |
|---|---|
| Dye | wavelength (in resin) |
| Compound 1 | 713 nm |
| Compound 2 | 752 nm |
| Compound 3 | 397 nm |
| Compound 4 | 773 nm |
| Compound 5 | 929 nm |

### <Spectral Characteristics of Near-Infrared Ray Absorbing Glass>

As the near-infrared ray absorbing glass, a ytterbium (Yb)-containing glass having a composition shown in the following table was manufactured with reference to Japanese Laid-Open Patent Publication No. S61-163138 and Japanese Laid-Open Patent Publication No. S56-78447.

TABLE 2

| | | Near-infrared ray absorbing glass | | | |
|---|---|---|---|---|---|
| | | Yb-containing | Yb-containing | Yb-containing | Yb-containing |
| | Type | glass 1 | glass 2 | glass 3 | glass 4 |
| Glass | Thickness | 1.25 mm | 1.25 mm | 0.8 mm | 0.56 mm |
| Glass | SiO₂ | 32.90 | — | — | 7.5 |
| composition | B₂O₃ | 23.20 | 63.00 | 63.00 | 23.6 |
| (mol %) | Al₂O₃ | — | 8.10 | 8.10 | — |
| | P₂O₅ | — | — | — | 7.5 |
| | ZnO | — | 6.70 | 6.70 | — |
| | BaO | — | 1.80 | 1.80 | — |
| | ZrO₂ | 7.30 | — | — | — |
| | La₂O₃ | 13.80 | 5.10 | 5.10 | — |
| | Ga₂O₃ | — | — | — | 14.2 |
| | Yb₂O₃ | 22.80 | 15.30 | 15.30 | 47.2 |

A spectral transmittance curve and a spectral reflectance curve in a wavelength range of 350 nm to 1,200 nm were measured with respect to the near-infrared ray absorbing glass (ytterbium-containing glass) and a non-absorbing glass (alkali glass, D263, 0.2 mm, manufactured by SCHOTT) using the ultraviolet-visible spectrophotometer, and an optical density was calculated based on an obtained transmittance.

Results are shown in the following table. The spectral characteristics shown in the following table were evaluated in terms of internal transmittance in order to avoid an influence of reflection at an air interface and a glass interface.

$$Internal transmittance ( \% ) = \{ measured {transmittance}_{( 0 deg )} / ( 100 - {reflectance}_{( 5 deg )} ) \} \times 100$$

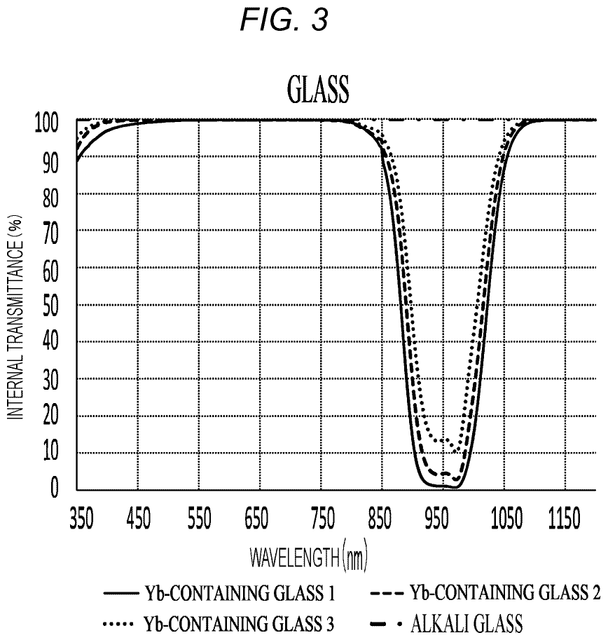

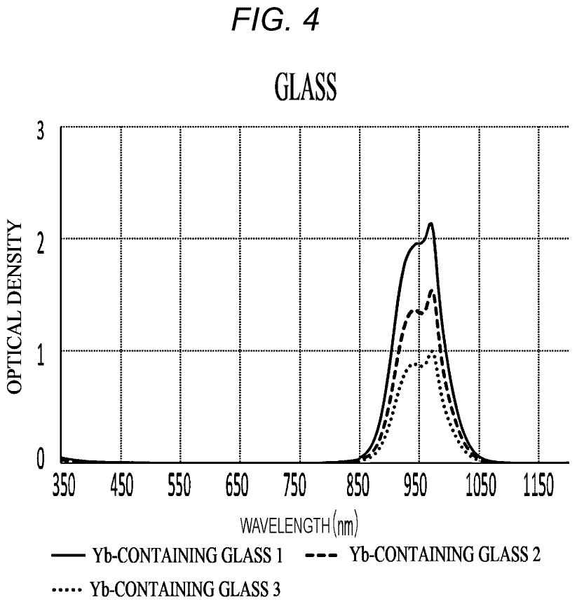

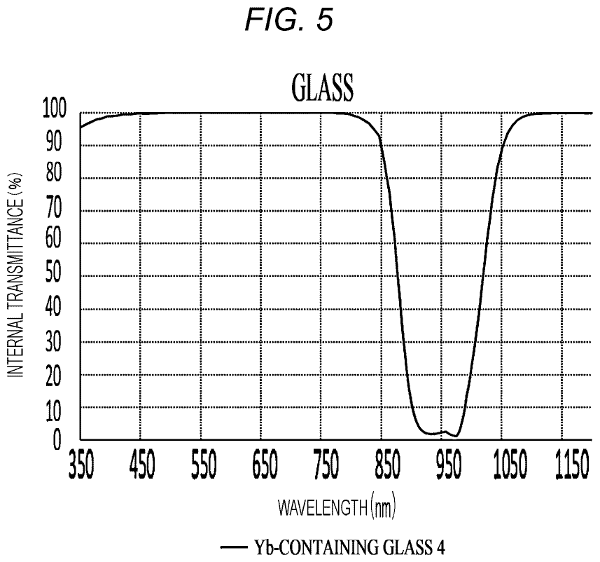

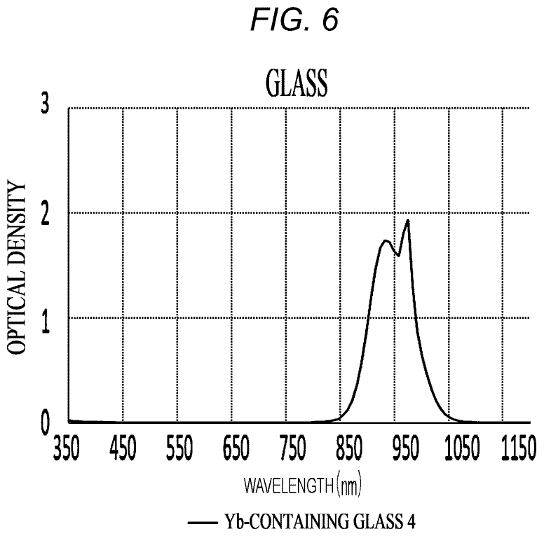

In addition, spectral transmittance curves of the Yb-containing glasses 1 to 3 and the alkali glass are shown in FIG. 3, optical density curves of the Yb-containing glasses 1 to 3 are shown in FIG. 4, a spectral transmittance curve of the Yb-containing glass 4 is shown in FIG. 5, and an optical density curve of the Yb-containing glass 4 is shown in FIG. 6.

TABLE 3

| | | Near-infrared ray absorbing glass | | | | Non-absorbing glass |
|---|---|---|---|---|---|---|
| Glass | Glass material type | Yb- | Yb- | Yb- | Yb- | Alkali |
| | | containing | containing | containing | containing | glass |
| | | glass 1 | glass 2 | glass 3 | glass 4 | |
| | Thickness | 1.25 mm | 1.25 mm | 0.8 mm | 0.56 mm | 0.2 mm |
| Spectral | OD_1000 | 0.812 | 0.565 | 0.368 | 0.368 | 0.00 |
| characteristics | OD_800 | 0.004 | 0.005 | 0.003 | 0.003 | 0.00 |
| | OD_1000/OD_800 | 227.552 | 113.345 | 115.137 | 115.14 | — |
| | OD_940- | 40.22 | 39.70 | 40.02 | 40.02 | — |
| | 960_ave/OD_840- | | | | | |
| | 860_ave | | | | | |
| | OD_920- | 8.07 | 9.21 | 9.23 | 9.23 | — |
| | 930_ave/OD_870- | | | | | |
| | 880_ave | | | | | |
| | Maximum absorption | 970 | 971 | 971 | 975 | — |
| | wavelength (nm) | | | | | |

### <Spectral Characteristics of Near-Infrared Ray Absorbing Ceramics>

As the near-infrared ray absorbing ceramics, 10% Yb:YAG ceramics (manufactured by Konoshima Chemical Co.,Ltd.), which is a polycrystalline sintered body containing ytterbium, was prepared. Here, “%” refers to a doping amount of Yb, that is, a composition ratio of Yb to an element to be replaced by Yb in a base material and Yb, and a unit thereof is at %. In the case of YAG, Y in Y₃Al₅O₁₂ is substituted with Yb, and thus “%” indicates a value of [Yb/(Yb+Y)]×100.

A spectral transmittance curve and a spectral reflectance curve in a wavelength range of 350 nm to 1,200 nm were measured with respect to the near-infrared ray absorbing ceramics (Yb:YAG ceramics) using the ultraviolet-visible spectrophotometer, and an optical density was calculated based on an obtained transmittance.

Results are shown in the following table. Spectral characteristics shown in the following table 4 were evaluated in terms of internal transmittance in order to avoid an influence of reflection at an air interface and a ceramics interface.

$$Internal transmittance ( \% ) = \{ measured {transmittance}_{( 0 deg )} / ( 100 - {reflectance}_{( 5 deg )} ) \} \times 100$$

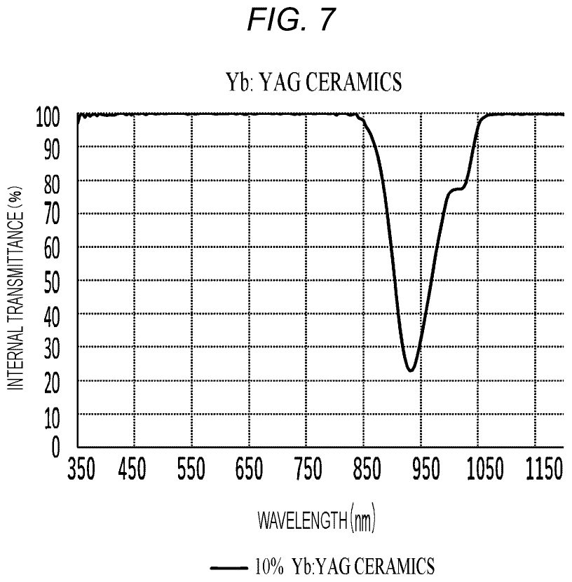

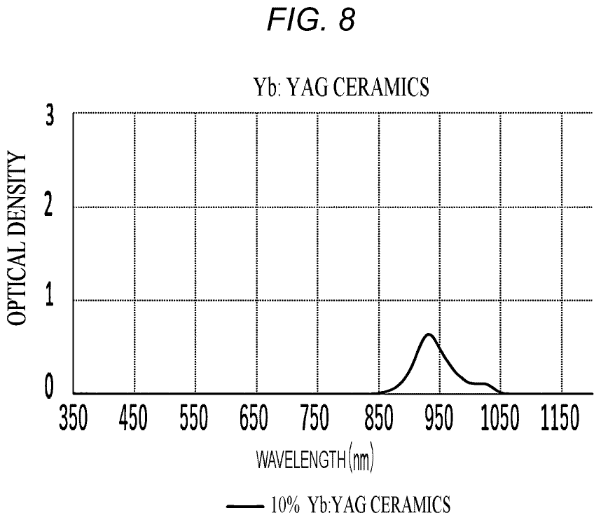

FIG. 7 illustrates a spectral transmittance curve of the 10% Yb:YAG ceramics, and FIG. 8 illustrates an optical density curve of the 10% Yb:YAG ceramics.

TABLE 4

| | | Near-infrared ray absorbing ceramics |
|---|---|---|
| Ceramics | Glass material type | 10% Yb: YAG ceramics |
| | Thickness | 3 mm |
| Spectral | OD_1000 | 0.119 |
| characteristics | OD_800 | 0.001 |
| | OD_1000/OD_800 | 140.50 |
| | OD_940-960_ave/OD_840-860 ave | 47.31 |
| | OD_920-930_ave/OD_870-880_ave | 9.80 |
| | Maximum absorption wavelength (nm) | 931 |

### Examples 1-1 and 1-2: Spectral Characteristics of Absorption Layer

Any of the dyes of the compounds 1 to 5 was mixed with a polyimide resin solution prepared in the same manner as in calculation of the spectral characteristics of the above-mentioned compounds at a concentration shown in the following table, and stirred and dissolved at 50° C. for 2 hours to obtain a coating solution. The obtained coating solution was applied onto an alkali glass (D263 glass, thickness: 0.2 mm, manufactured by SCHOTT) by a spin coating method to form an absorption layer having a film thickness shown in the following table.

With respect to the obtained absorption layer, a spectral transmittance curve and a spectral reflectance curve in a wavelength range of 350 nm to 1,200 nm were measured using the ultraviolet-visible spectrophotometer.

Results are shown in the following table.

The spectral characteristics shown in the following table were evaluated in terms of internal transmittance in order to avoid an influence of reflection at an air interface and a glass interface.

$$Internal transmittance ( \% ) = \{ measured {transmittance}_{( 0 deg )} / ( 100 - {reflectance}_{( 5 deg )} ) \} \times 100$$

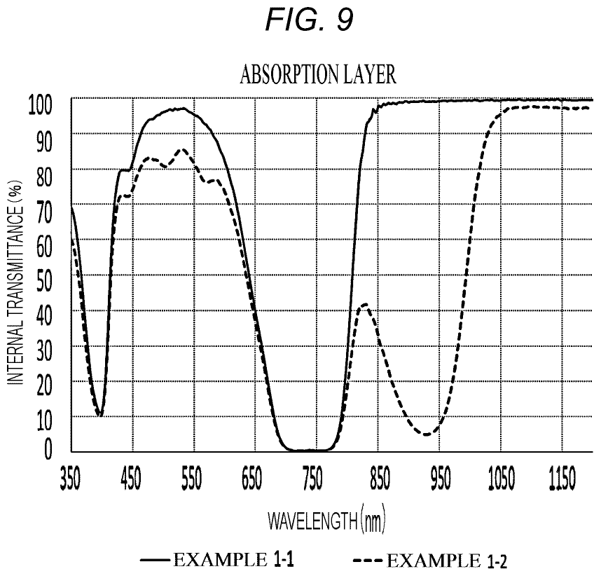

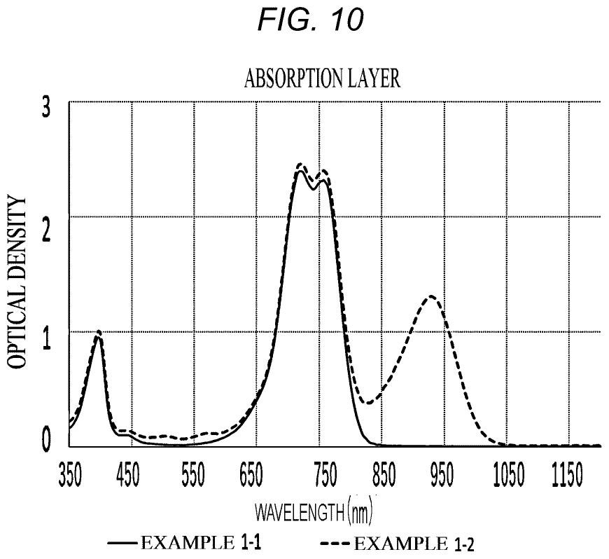

FIG. 9 illustrates spectral transmittance curves of the absorption layers of Examples 1-1 and 1-2, and FIG. 10 illustrates optical density curves of the absorption layers of Examples 1-1 and 1-2.

Examples 1-1 and 1-2 are reference examples.

TABLE 5

| | | Example | Example |
|---|---|---|---|
| Absorption layer | | 1-1 | 1-2 |
| Film thickness of absorption layer (μm) | | 1.3 | 1.5 |
| Added | Compound 1 (λMAX: 713 nm) | 4.1 | 3.5 |
| amount | Compound 2 (λMAX: 752 nm) | 3.8 | 3.2 |
| of dye | Compound 3 (λMAX: 397 nm) | 3.1 | 2.4 |
| (mass %) | Compound 4 (λMAX: 773 nm) | 3.0 | 2.0 |
| | Compound 5 (λMAX: 929 nm) | — | 5.2 |
| Spectral | λA_VIS(30%) (nm) | 659 | 656 |
| characteristics | λA_IR(30%) (nm) | 801 | 810 |
| | \|λA_IR(30%)-λA_VIS(30%)\| (nm) | 142 | 156 |
| | OD_720 | 2.40 | 2.46 |
| | OD_450 | 0.09 | 0.13 |
| | OD_720-OD_450 | 2.31 | 2.33 |
| | OD_1000 | 0.00 | 0.22 |
| | OD_800 | 0.54 | 0.74 |
| | OD_1000/OD_800 | 0.01 | 3.31 |
| | OD_940-960_ave/OD_840-860 ave | 0.34 | 2.57 |
| | OD_920-930_ave/OD_870-880 ave | 0.60 | 1.79 |

### Example 2-1: Spectral Characteristics of Optical Filter

A first dielectric multilayer film (reflective film) was formed by alternately laminating SiO₂ and TiO₂ on one surface of infrared ray absorbing glass (Yb-containing glass 1) by vapor deposition.

A resin solution was applied to a surface of the first dielectric multilayer film with the same composition as that of the absorption layer of Example 1-1, and an organic solvent was removed by sufficiently heating to form an absorption layer having a thickness of 1.3 μm.

A second dielectric multilayer film (antireflection film) was formed by alternately laminating SiO₂ and TiO₂ on a surface of the absorption layer by vapor deposition.

Thus, an optical filter 2-1 was manufactured.

### Example 2-2

An optical filter 2-2 was manufactured in the same manner as in Example 2-1 except that the infrared ray absorbing glass was changed from the Yb-containing glass 1 to the Yb-containing glass 2.

### Example 2-3

An optical filter 2-3 was manufactured in the same manner as in Example 2-1 except that the infrared ray absorbing glass was changed from the Yb-containing glass 1 to the Yb-containing glass 3.

### Example 2-4

An optical filter 2-4 was manufactured in the same manner as in Example 2-1 except that the infrared ray absorbing glass (Yb-containing glass 1) was changed to a non-absorbing glass (alkali glass, D263, 0.3 mm, manufactured by SCHOTT).

### Example 2-5

An optical filter 2-5 was manufactured in the same manner as in Example 2-1 except that the infrared ray absorbing glass (Yb-containing glass 1) was changed to a non-absorbing glass (alkali glass, D263, 0.2 mm, manufactured by SCHOTT), and the absorption layer was changed from that of Example 1-1 to that of Example 1-2 having a thickness of 1.5 μm.

### Example 2-6

A first dielectric multilayer film (reflective film) was formed by alternately laminating SiO₂ and TiO₂ on one surface of a non-absorbing glass (alkali glass, D263, 0.2 mm, manufactured by SCHOTT) by vapor deposition.

A second dielectric multilayer film (antireflection film) was formed by alternately laminating SiO₂ and TiO₂ on the other surface of the non-absorbing glass by vapor deposition. Thus, an optical filter 2-6 was manufactured.

### Example 2-7

An optical filter 2-7 was manufactured in the same manner as in Example 2-1 except that the inorganic material (absorber) was changed from the Yb-containing glass 1 to the Yb-containing glass 4.

### Example 2-8

An optical filter 2-8 was manufactured in the same manner as in Example 2-1 except that the inorganic material (absorber) was changed from the Yb-containing glass 1 to the 10% Yb:YAG ceramics.

Reflectance of each of the above-mentioned optical filters measured with the first dielectric multilayer film as the plane of incidence is shown in the following table.

With respect to each of the optical filters obtained as described above, spectral transmittance curves at an incident angle of 0 degrees and an incident angle of 35 degrees and a spectral reflectance curve at an incident angle of 5 degrees in a wavelength range of 350 nm to 1,200 nm were measured using the ultraviolet-visible spectrophotometer.

Respective characteristics shown in the following tables 6 and 7 were calculated based on the obtained data of the spectral characteristics.

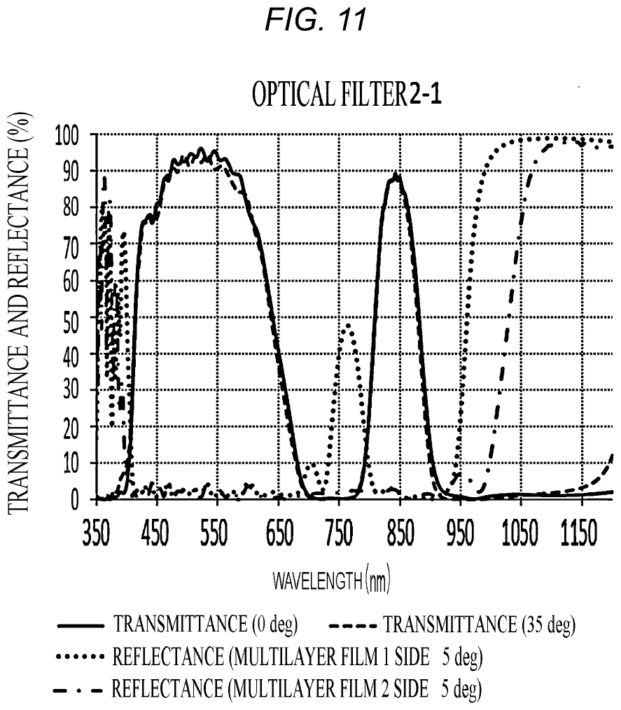

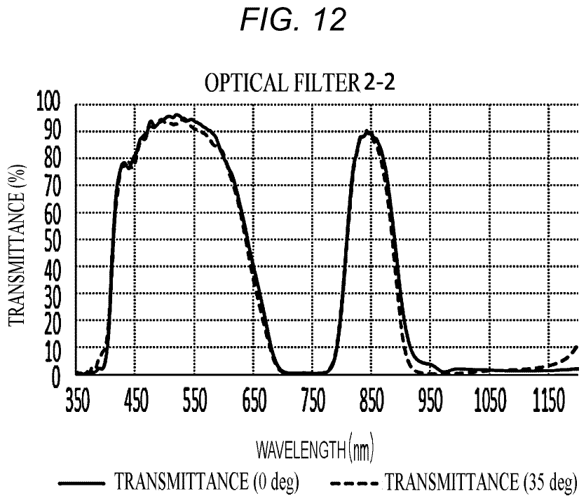

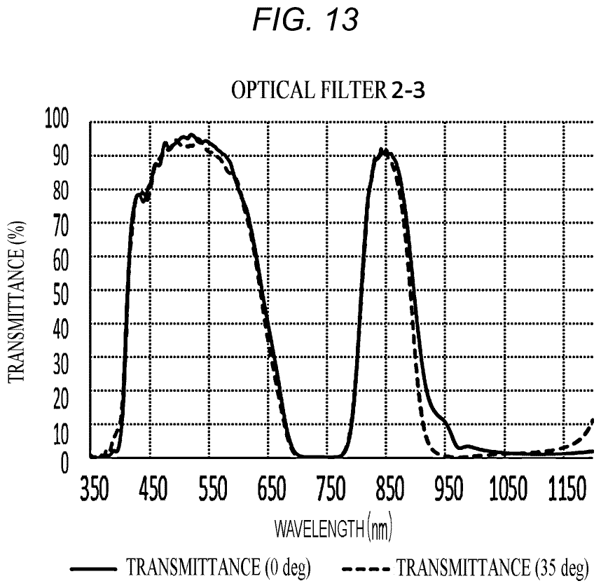

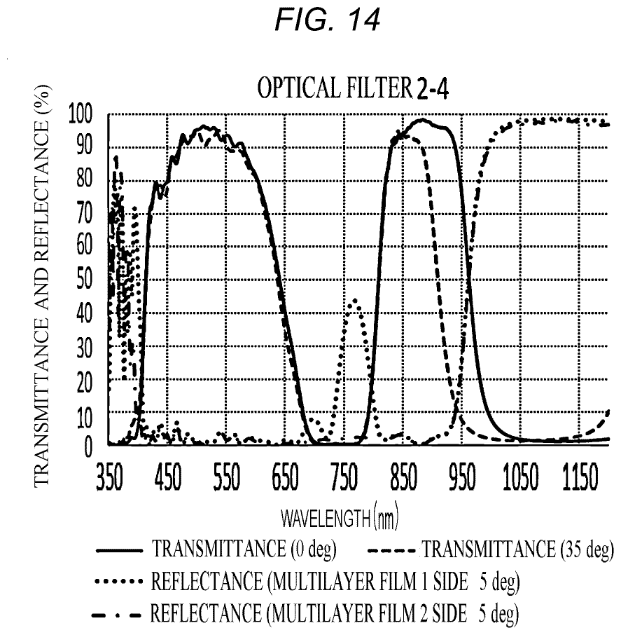

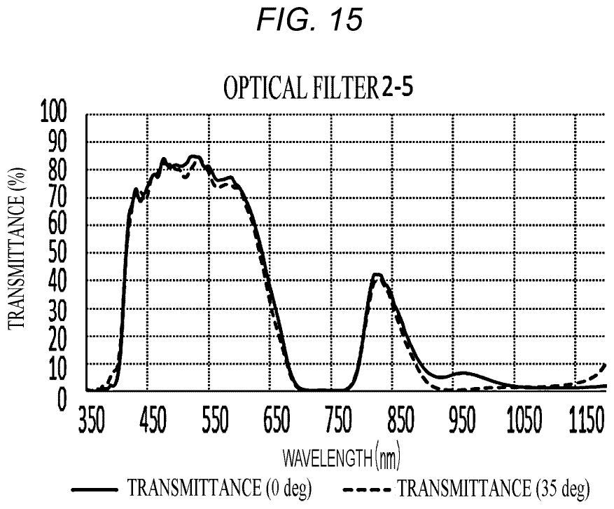

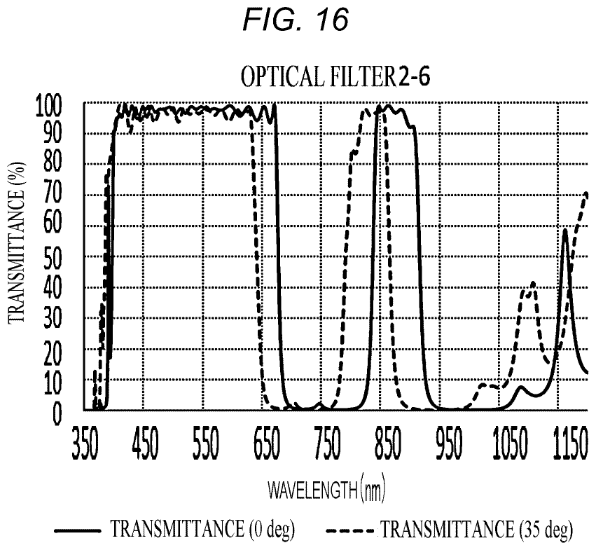

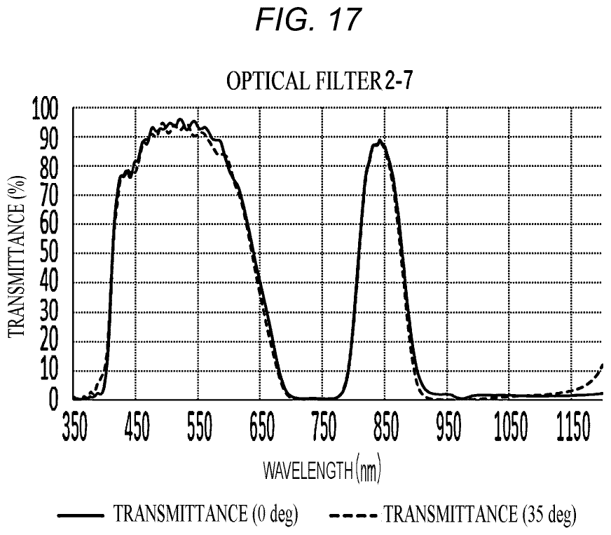

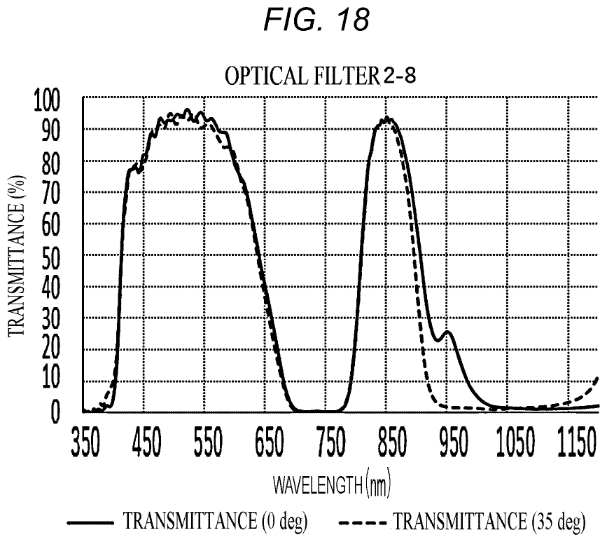

Spectral transmittance (reflectance) curves of the optical filters of Examples 2-1 to 2-8 are illustrated in FIGS. 11 to 18, respectively.

Examples 2-1 to 2-3, 2-7, and 2-8 are inventive examples, and Examples 2-4 to 2-6 are comparative examples.

TABLE 6

| | | | Example 2-1 | Example 2-2 | Example 2-3 |
|---|---|---|---|---|---|
| Configuration | Second dielectric | Function | Antireflection | Antireflection | Antireflection |
| of optical filter | multilayer film | Number of layers | 9 L | 9 L | 9 L |
| | | Film thickness | 447 nm | 447 nm | 447 nm |
| | Absorption layer | | Example 1-1 | Example 1-1 | Example 1-1 |
| | Inorganic material | Glass material type | Yb-containing | Yb-containing | Yb-containing |
| | (absorber) | | glass 1 | glass 2 | glass 3 |
| | | Thickness | 1.25 mm | 1.25 mm | 0.8 mm |
| | First dielectric | Function | Reflection | Reflection | Reflection |
| | multilayer film | Number of layers | 55 L | 55 L | 55 L |
| | | Film thickness | 2,962 nm | 2,962 nm | 2,962 nm |
| | Spectral | R450-600(5 deg)AVE (%) | 2.2 | 1.8 | 1.8 |
| | characteristics of | R700-750(5 deg)AVE (%) | 13.5 | 12.1 | 12.1 |
| | first dielectric | R800-900(5 deg)AVE (%) | 1.9 | 1.9 | 1.9 |
| | multilayer film | R1000-1200(5 deg)AVE (%) | 98.1 | 98.0 | 98.0 |
| Spectral | T450-600(0 deg)AVE (%) | | 90.9 | 91.5 | 91.5 |
| characteristics | T800-900(0 deg)MAX (%) | | 89.3 | 90.2 | 91.8 |
| | T930-950(0 deg)MAX (%) | | 1.5 | 5.1 | 14.6 |
| | T700-750(0 deg)AVE (%) | | 0.5 | 0.5 | 0.5 |
| | T1050-1200(0 deg)MAX (%) | | 2.2 | 2.1 | 2.1 |
| | T800-1000(0 deg)MAX (%) | | 89.3 | 90.2 | 91.8 |
| | \|λIRL(0 deg)(50%)-λIRL(35 deg)(50%)\| (nm) | | 3.0 | 4.0 | 6.0 |
| | \|10/[λIRL(0 deg)(45%)-λIRL(0 deg)(55%)\| (nm) | | 2.1 | 2.0 | 1.8 |
| | \|λIRS(0 deg)(50%)-λIRS(35 deg)(50%)\| (nm) | | 1.0 | 1.0 | 1.0 |
| | λIRL(0 deg)(50%)-λIRS(0 deg)(50%) (nm) | | 73.0 | 81.0 | 89.0 |
| | λIRL(35 deg)(50%)-λIRS(35 deg)(50%) (nm) | | 69.0 | 76.0 | 82.0 |
| | [λIRL(35deg)(50%)-λIRS(35 deg)(50%)]- | | 4.0 | 5.0 | 7.0 |
| | [λIRL(0 deg)(50%)-λIRS(0 deg)(50%)]\| (nm) | | | | |
| | IRP-A(0 deg) (% · nm) | | 6,545.3 | 7,303.8 | 8,229.9 |
| | IRP-A(35 deg) (% nm) | | 6,453.0 | 7,153.4 | 7,855.3 |
| | IRP-A(35 deg)/IRP-A(0 deg) | | 0.99 | 0.98 | 0.95 |
| | [IRP-A(35 deg)/VIS-A(35 deg)]/[IRP-A(0 deg)/VIS- | | 1.01 | 1.02 | 1.04 |
| | A(0 deg)\| | | | | |
| | \|λIRR(5 deg)(50%)-λIRL(0 deg)(50%) | | 80.0 | 72.0 | 64.0 |
| | | | Example 2-4 | Example 2-5 | Example 2-6 |
| Configuration | Second dielectric | Function | Antireflection | Antireflection | Antireflection |
| of optical filter | multilayer film | Number of layers | 9 L | 9 L | 82 L |
| | | Film thickness | 447 nm | 447 nm | 342 nm |
| | Absorption layer | | Example 1-1 | Example 1-2 | None |
| | Inorganic material | Glass material type | Alkali | Alkali | Alkali |
| | (absorber) | Thickness | 0.3 mm | 0.2 mm | 0.21 mm |
| | First dielectric | Function | Reflection | Reflection | Reflection |
| | multilayer film | Number of layers | 55 L | 55 L | 50 L |
| | | Film thickness | 2,962 nm | 2,962 nm | 4,079 nm |
| | Spectral | R450-600(5 deg)AVE (%) | 2.0 | 1.9 | 2.2 |
| | characteristics of | R700-750(5 deg)AVE (%) | 10.8 | 10.2 | 99.2 |
| | first dielectric | R800-900(5 deg)AVE (%) | 2.5 | 2.2 | 37.4 |
| | multilayer film | R1000-1200(5 deg)AVE (%) | 98.0 | 98.0 | 88.9 |

| | | | | |
|---|---|---|---|---|
| Spectral | T450-600(0 deg)AVE (%) | 91.3 | 80.0 | 97.8 |
| characteristics | T800-900(0 deg)MAX (%) | 98.6 | 42.4 | 99.0 |
| | T930-950(0 deg)MAX (%) | 94.7 | 6.1 | 6.1 |
| | T700-750(0 deg)AVE (%) | 0.5 | 0.5 | 0.8 |
| | T1050-1200(0 deg)MAX (%) | 2.0 | 1.9 | 58.6 |
| | T800-1000(0 deg)MAX (%) | 98.6 | 42.4 | 99.0 |
| | \|λIRL(0 deg)(50%)-λIRL(35 deg)(50%)\| (nm) | 53.0 | Not measurable | 51.0 |
| | \|10/[λIRL(0 deg)(45%)-λIRL(0 deg)(55%)\| (nm) | 2.2 | Not measurable | 6.7 |
| | \|λIRS(0 deg)(50%)-λIRS(35 deg)(50%)\| (nm) | 1.0 | 0.0 | 46.0 |
| | λIRL(0 deg)(50%)-λIRS(0 deg)(50%) (nm) | 154.0 | Not measurable | 79.0 |
| | λIRL(35 deg)(50%)-λIRS(35 deg)(50%) (nm) | 100.0 | Not measurable | 74.0 |
| | \|[λIRL(35 deg)(50%)-λIRS(35 deg)(50%)]- | 54.0 | Not measurable | 5.0 |
| | [λIRL(0 deg)(50%)-λIRS(0 deg)(50%)]\| (nm) | | | |
| | IRP-A(0 deg) (% · nm) | 14,734.9 | 2,439.2 | 7,660.5 |
| | IRP-A(35 deg) (% · nm) | 11,520.6 | 2,291.7 | 3,542.9 |
| | IRP-A(35 deg)/IRP-A(0 deg) | 0.78 | 0.94 | 0.46 |
| | [IRP-A(35 deg)/VIS-A(35 deg)]/[IRP-A(0 deg)/VIS- | 1.27 | 1.06 | 1.94 |
| | A(0 deg)\| | | | |
| | \|λIRR(5 deg)(50%)-λIRL(0 deg)(50%)\| | −1.0 | Not measurable | −1.0 |

TABLE 7

| | | | Example 2-7 | Example 2-8 |
|---|---|---|---|---|
| Configuration | Second dielectric | Function | Antireflection | Antireflection |
| of optical filter | multilayer film | Number of layers | 9 L | 9 L |
| | | Film thickness | 447 nm | 447 nm |
| | Absorption layer | | Example 1-1 | Example 1-1 |
| | Inorganic material | Glass material typc | Yb-containing | 10% Yb: YAG |
| | (absorber) | | glass 4 | |
| | | Thickness | 0.56 mm | 3 mm |
| | First dielectric | Function | Reflection | Reflection |
| | multilayer film | Number of layers | 55 L | 55 L |
| | | Film thickness | 2,962 nm | 2,962 nm |
| | Spectral | R450-600(5 deg)AVE (%) | 2.3 | 2.3 |
| | characteristics of | R700-750(5 deg)AVE (%) | 13.7 | 13.7 |
| | first dielectric | R800-900(5 deg)AVE (%) | 1.9 | 2.1 |
| | multilayer film | R1000-1200(5 deg)AVE (%) | 98.1 | 98.1 |

| | | | |
|---|---|---|---|
| Spectral | T450-600(0 deg)AVE (%) | 91.1 | 91.0 |
| characteristics | T700-750(0 deg)AVE (%) | 0.5 | 0.5 |
| | T1050-1200(0 deg)MAX (%) | 2.2 | 2.2 |
| | T800-1000(0 deg)MAX (%) | 89.2 | 93.8 |
| | λIRL(0 deg)(50%)-λIRL(35 deg)(50%)\| (nm) | 2.0 | 10.0 |
| | \|10/[λIRL(0 deg)(45%)-λIRL(0 deg)(55%)]\| (nm) | 1.9 | 1.6 |
| | \|λIRS(0 deg)(50%)-λIRS(35 deg)(50%)\| (nm) | 1.0 | 0.0 |
| | λIRL(0 deg)(50%)-λIRS(0 deg)(50%) (nm) | 70.0 | 97.0 |
| | λIRL(35 deg)( 50%)-λIRS(35 deg)(50%) (nm) | 67.0 | 87.0 |
| | \|[λIRL(35 deg)(50%)-λIRS(35 deg)(50%)]- | 3.0 | 10.0 |
| | [λIRL(0 deg)(50%)-λIRS(0 deg)(50%)]\| (nm) | | |
| | IRP-A(0 deg) (% · nm) | 6,307.3 | 9,952.9 |
| | IRP-A(35 deg) (% · nm) | 6,238.2 | 8,502.5 |
| | IRP-A(35 deg)/IRP-A(0 deg) | 1.0 | 0.9 |
| | [IRP-A(35 deg)/VIS-A(35 deg)]/[IRP-A(0 deg)/ | 1.0 | 1.2 |
| | VIS-A(0 deg)] | | |
| | \|λIRR(5 deg)(50%)-λIRL(0 deg)(50%)\| | 83.0 | 56.0 |
| | T800-900(0 deg)MAX (%) | 89.2 | 93.8 |
| | T930-950(0 deg)MAX (%) | 2.0 | 25.7 |

From the above-mentioned results, it is understood that the optical filters of Examples 2-1, 2-2, and 2-3 are optical filters in which transmittance of visible light and near-infrared light of 800 nm to 1,000 nm, particularly 800 nm to 900 nm is excellent, light shielding properties of other near-infrared light in a wavelength region, particularly of 1,050 nm to 1,200 nm is excellent, and further a shift of the spectral curve is small even at a high incident angle.

In the optical filter of Example 2-4 in which the ytterbium-containing glass was not used and light in a wavelength region longer than 850 nm was shielded due to the reflection characteristics of the dielectric multilayer film, a result that |λ_{IRL(0 deg)(50%)}-λ_{IRL(35 deg)(50%)}| exceeded 15 nm, and a spectral curve in a wavelength region longer than λ_{800-1000(0 deg)MAX} shifted depending on an incident angle was obtained.

In the optical filter of Example 2-5 in which the ytterbium-containing glass was not used and light in a wavelength region longer than 850 nm was shielded due to the absorption characteristics of the near-infrared light absorbing dye, a result that the maximum transmittance T_{800-1000(0 deg)MAX} was lower than 60%, and transmittance of the near-infrared light was low was obtained.

In the optical filter of Example 2-6 in which the ytterbium-containing glass and the near-infrared light absorbing dye were not used and light in a part of the near-infrared light region was shielded due to only the reflection characteristics of the dielectric multilayer film, a result that |λ_{IRL(0 deg)(50%)}-λ_{IRL(35 deg)(50%)}| exceeded 15 nm, and a spectral curve in a wavelength region longer than λ_{800-1000(0 deg)MAX} shifted depending on an incident angle was obtained.

In addition, from the above-mentioned results, it is understood that the optical filters of Examples 2-7 and 2-8 are optical filters in which transmittance of visible light and near-infrared light of 800 nm to 1,000 nm, particularly 800 nm to 900 nm is excellent, light shielding properties of other near-infrared light in a wavelength region, particularly of 1,050 nm to 1,200 nm is excellent, and further a shift of the spectral curve is small even at a high incident angle.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2022-073741) filed on Apr. 27, 2022, the content of which is incorporated herein by reference.

### INDUSTRIAL APPLICABILITY

The optical filter according to the present invention is excellent in transmittance of visible light and has shielding properties of specific near-infrared light. In recent years, the optical filter has been useful for applications of information acquisition devices such as cameras and sensors for transport machines, for which high performance has been achieved.

### REFERENCE SIGNS LIST

1A, 1B: optical filter
10: absorber
21, 22: dielectric multilayer film
30: absorption layer

What is claimed is:

1. An optical filter comprising:
an absorber comprising an inorganic material comprising ytterbium;
an absorption layer comprising a dye and a resin, the dye having a maximum absorption wavelength between 350 nm and 1,200 nm; and
a dielectric multilayer film.

2. The optical filter according to claim 1, wherein the absorber has a flat plate shape.

3. The optical filter according to claim 1, wherein the absorber has a thickness of 3 mm or less.

4. The optical filter according to claim 1, wherein the absorber comprises a glass comprising ytterbium, and
the glass comprises 10 mol % or more of Yb₂O₃ in terms of mol % based on an oxide.

5. The optical filter according to claim 1, wherein the absorber comprises a single crystal comprising ytterbium or a polycrystalline sintered body comprising ytterbium, and
the single crystal or the polycrystalline sintered body comprises 10 mol % or more of Yb₂O₃ in terms of mol % based on an oxide, or has a doping amount of Yb of 10 at % or more in terms of a composition ratio of Yb to an element to be replaced by Yb in a base material and Yb.

6. The optical filter according to claim 1, wherein the absorber satisfies the following spectral characteristic (iii-1):
(iii-1) an average optical density OD_{940-960 AVE} at a wavelength of 940 nm to 960 nm/an average optical density OD_{840-860_AVE} at a wavelength of 840 nm to 860 nm>5.

7. The optical filter according to claim 1, wherein the absorber satisfies the following spectral characteristic (iii-2):
(iii-2) an average optical density OD_{920-930_AVE} at a wavelength of 920 nm to 930 nm/an average optical density OD_{870_880_AVE} at a wavelength of 870 nm to 880 nm>3.

8. The optical filter according to claim 1, wherein the following spectral characteristic (i-2) is satisfied:
(i-2) in a spectral transmittance curve at a wavelength of 800 nm to 900 nm and an incident angle of 0 degrees, a maximum transmittance T_{800-900(0 deg)MAX} is 60% or more.

9. The optical filter according to claim 1, wherein the following spectral characteristic (i-3) is satisfied:
(i-3) in a spectral transmittance curve at a wavelength of 930 nm to 950 nm and an incident angle of 0 degrees, a maximum transmittance T_{930-950(0 dog)MAX} is 20% or less.

10. The optical filter according to claim 1, wherein the following spectral characteristic (i-1) is satisfied:
(i-1) in a spectral transmittance curve at a wavelength of 450 nm to 600 nm and an incident angle of 0 degrees, an average transmittance T_{450-600(0 deg)AVE} is 60% or more.

11. An imaging device comprising the optical filter according to claim 1.
